(19) United States
(12) Patent Application Publication
(10) Pub. No.: US 2006/0250919 A1
(43) Pub. Date: Nov. 9, 2006

(54) Method of and apparatus for optimizing write strategy on a rewritable optical disk based on study performed on recording information area

(75) Inventor: Min-Seok Kim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/345,374

(22) Filed: Feb. 2, 2006

(30) Foreign Application Priority Data
May 9, 2005 (KR) 2005-38417

(51) Int. Cl. G11B 7/0045

(52) U.S. Cl. 369/59.11

(57) ABSTRACT

A method of optimizing a write strategy (WS) by performing a WS study on a recording information area and an optical recording apparatus employing the method. A WS study area is determined from a recording information area which records a recording information about a user data recorded to a user data area of the optical disk, and an optimal WS is obtained by performing a WS study on the determined WS study area. Accordingly, an optimal WS with respect to the user data area which has been used several times for data recording and also record the user data is obtained according to the optimal WS, and thus a recording quality of the optical disk is improved.

### CROSS-REFERENCE TO RELATED APPLICATIONS

This application claims the benefit of Korean Patent Application No. 2005-38417, filed on May 9, 2005, in the Korean Intellectual Property Office, the disclosure of which is incorporated herein by reference.

### BACKGROUND OF THE INVENTION

1. Field of the Invention

Aspects of the present invention relate to a write strategy (WS) optimizing method and an optical recording apparatus employing the optimized write strategy. More particularly, aspects of the present invention relate to a method of optimizing a WS based on a WS study performed on a recording information area, and an optical recording apparatus employing the optimized write strategy.

2. Description of the Related Art

An optical recording apparatus performs a WS study before recording user data to a user data area of a mounted optical disk. The WS study is performed to obtain an optimal WS. The reason why the WS study precedes the user data recording process is that a user data recording quality depends on the optimal WS.

The WS study is performed on a test recording area of the optical disk. The test recording area is provided in the optical disk and dedicated to the WS study. Once a portion of the test recording area has been used for a test recording, the portion cannot be again used for the test recording. That is, the WS study is performed on a unused portion of the test recording area that has never been used for a test recording.

On the other hand, an optical disk may have a user data area that enables user data to be recorded several times. Such an optical disk is called a rewritable optical disk. Like a general optical disk, the rewritable optical disk has a test recording area to perform a WS study and the WS is normally performed on an unused portion of the test recording area that has never been used for a test recording.

However, where the user data area has a history of recording the user data and the test recording area to perform the WS study for optimizing the WS has no history of recording data, a discrepancy between medium characteristics of the user data area that has been used several times for data recording and medium characteristics of the test recording area that has never been used for data recording may exist. This discrepancy results from changes in the medium characteristic of the user data area caused by the several recording operations.

Therefore, if the WS is obtained by performing the WS study on the test recording area, the WS may not suitable for use in recording the user data to the user data area. This becomes a greater problem as the number of data recording operations on a same portion of the user data area increases.

### SUMMARY OF THE INVENTION

Accordingly, in order to solve the above and/or other problems, an aspect of the present invention is to provide a method for optimizing a WS by performing a WS study on a recording information area having a medium characteristic which is similar to a user data area, and an optical recording apparatus employing the same.

The above and/or other aspects are achieved by providing a method of optimizing a write strategy (WS), including determining a WS study area from a recording information area which is provided in a certain area of a rewritable optical disk and records a recording information about a user data recorded to a user data area of the optical disk, and obtaining an optimal WS by performing a WS study on the determined WS study area.

The WS study area may be determined to be not-for-use blocks of the recording information area, wherein the not-for-use blocks are not for use in recording the recording information about the user data recorded to the user data area.

The WS study not-for-use blocks may be blocks of the recording information area that have been used for the recording of the recording information a predetermined number of times.

The WS study area may be determined to be the not-for-use blocks of the recording information area if the number of not-for-use blocks is greater than or equal to a second predetermined number.

If the number of the not-for-use blocks is less than the second predetermined number, the determining of the WS study area may be skipped and an optimal WS may be obtained by performing a WS study on a test recording area of the optical disk.

The method of optimizing a WS may further include: determining whether a number of user data recording operations performed on a portion of the user data recording area is greater than or equal to a third predetermined number; controlling the user data to be recorded according to the WS obtained based on the WS study performed on the determined WS study area, if the number of user data recording operations is greater than or equal to the third predetermined number; and controlling the user data to be recorded according to the WS obtained based on the WS study performed on a test recording area, if the number of user data recording operations is less than the third predetermined number.

The above and/or other aspects are also achieved by providing an optical recording apparatus including a determination unit determining a WS study area from a recording information area of a rewritable optical disk, the recording information area including recording information about user data recorded to a user data area of the rewritable optical disk, and a control unit obtaining an optimal WS by performing a WS study on the WS study area determined by the determination unit.

The determination unit may determine the WS study area to be not-for-use blocks of the recording information area, wherein the not-for-use blocks are not for use in recording the recording information about the user data recorded to the user data area.

The determination unit may determine the not-for-use blocks to be blocks of the recording information area that have been used for the recording of the recording information a predetermined number of times.

The determination unit may determine the WS study area to be the not-for-use blocks of the recording information area if the number of not-using blocks is greater than or equal to a second predetermined number.

If the number of the not-for-use blocks is less than the second predetermined number, the determination unit may skip the determination of the WS study area and determine the optimal WS based on a WS study performed on a test recording area of the rewritable optical disk.

The optical recording apparatus may further include a judgment unit to judge the number of the user data recording operations performed on a portion of the user data recording area, wherein if the number of user data recording operations is greater than or equal to the third predetermined number, the control unit controls the user data to be recorded according to the WS obtained based on the WS study performed on the WS study area determined by the determination unit, and if the number of user data recording operations is less than the third predetermined number, the control unit controls the user data to be recorded according to the WS obtained based on the WS study performed on the test recording area.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view illustrating a format of a rewritable optical disk applicable to the present invention;

FIG. 2 is a block diagram illustrating an optical recording apparatus which optimizes a WS by performing a WS study on a recording information area according to an embodiment of the present invention; and

FIG. 3 is a flowchart illustrating a method for optimizing a WS by performing a WS study on a recording information area according to an embodiment of the present invention.

### DETAILED DESCRIPTION OF THE EMBODIMENT

Reference will now be made in detail to the present embodiments of the present invention, examples of which are illustrated in the accompanying drawings, wherein like reference numerals refer to the like elements throughout. The embodiments are described below in order to explain the present invention by referring to the figures.

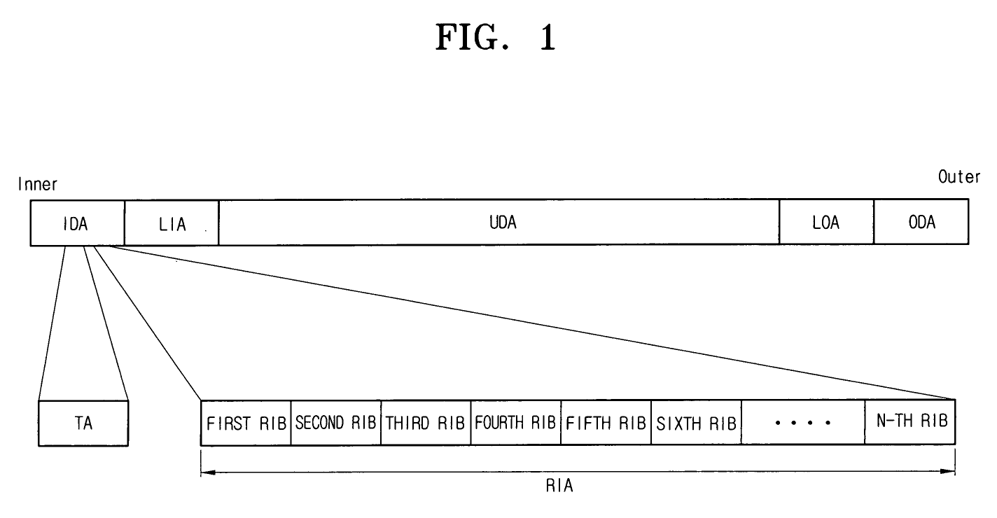

FIG. 1 illustrates a format of a rewritable optical disk applicable to the present invention. Referring to FIG. 1, the rewritable optical disk (referred to as “an optical disk”, hereinbelow) has an inner drive area (IDA), a lead in area (LIA), a user data area (UDA), a lead out area (LOA), and an outer drive area (ODA) sequentially from an inner side of the disk to an outer side of the disk.

The UDA records user data (UD) such as audio/video (AV) data.

The IDA, LIA, LOA and ODA record data about managing, reproducing and recording operations of the optical disk. The IDA has a test area (TA) and a recording information area (RIA). The TA is used for a write strategy (WS) study and the RIA records recording information (RI) about the UD recorded to the UDA.

The RIA includes a plurality of recording information blocks (RIBs) (first to N-th RIBs). The recording of recording information (RI) is performed with the recording of UD. To be specific, if a predetermined amount of UD is recorded to the UDA, information about the currently recorded UD is initially recorded to one of the RIBs in the RI. After that, if a predetermined amount of UD is additionally recorded to the UDA, information previously recorded to the RIA is updated with the additionally recorded UD. That is, the RI continues to be updated during the recording of the UD.

The RI is about the recorded UD and thus is important for reproducing the UD. Therefore, if the UD recording is normally performed but the ‘RI initial recording or rewriting’ (referred to as ‘RI recording’ hereinafter) is not normally performed, it is impossible to reproduce the UD.

Accordingly, after the RI recording is completed, it is be determined whether the RI recording has been normally performed. If the RI recording has been normally performed on a certain RIB, the certain RIB continues to perform the RI recording. On the other hand, if the RI recording has been abnormally performed on the certain RIB, the certain RIB is not further used for the RI recording, and the next RIB is scheduled to perform the RI recording. For example, if an RI recording is performed on a first RIB but the recording on the first RIB is determined to be abnormal, the second RIB is scheduled to perform the RI recording.

Accordingly, where RIBs located prior to a current RIB recording the RI have been used to record the RI several times, such RIBs would not be for use in recording UD. For example, if an RI recording is currently performed on the sixth RIB, the first to fifth RIBs have already been used to record the RI several times and thus the first to fifth RIBs would not be for use in recording the RI about the UD.

Since the RIBs located prior to the current RIB have been used for RI recording, the medium characteristics of the prior recorded RIBs are similar to that of the UDA which changes due to the several UD recording operations.

Examples of optical disks to which aspects of the present invention may be applied include a rewritable compact disk (CD), digital video disk (DVD), blue-ray disk (BD) and an HD-DVD. Other types of rewritable optical disk may also be used in embodying the present invention.

Other terms may be used for the respective areas of the optical disk, depending on the kinds of optical disks. For example, although the term ‘RIA’ is used for the DVD-RW shown in FIG. 1, other corresponding terms, e.g., ‘table of contents zone’ (TCZ) and ‘disk identification zone’ (DIZ), may be used for the DVD+RW and the DVD-RAM, respectively. Hereinbelow, the RIA, TCZ and DIZ are all referred to as ‘RIA’. Also, although the term ‘TA’ is used in FIG. 1, other corresponding terms, e.g., ‘power calibration area’ (PCA) and ‘inner disk test zone’ (IDTZ), may be used for the DVD-RW and DVD+RW, respectively. Hereinbelow, the PCA and IDTZ are all referred to as ‘TA’.

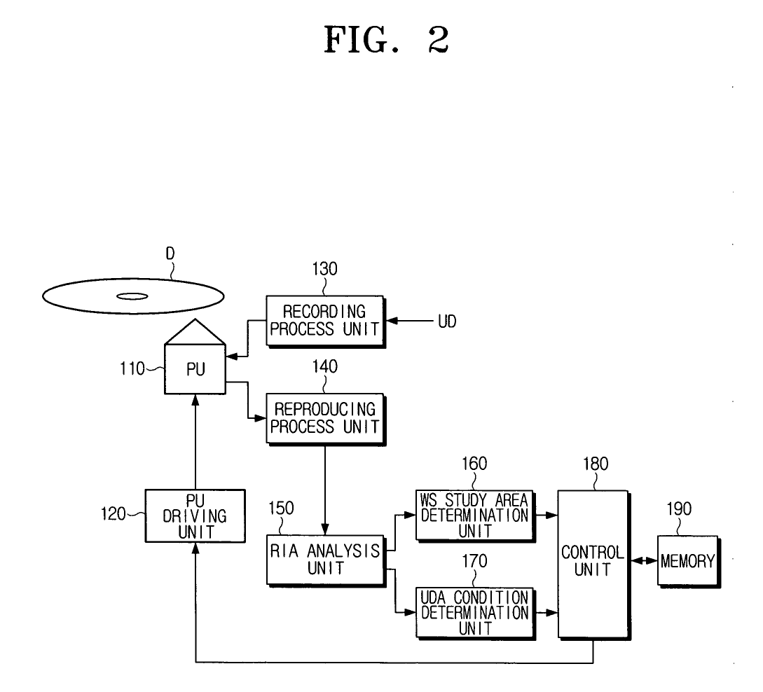

FIG. 2 is a block diagram illustrating an optical recording apparatus according to an embodiment of the present invention. The optical recording apparatus shown in FIG. 2 performs a WS study on an RIA and thereby optimizes a WS. More specifically, the optical recording apparatus optimizes the WS by performing the WS study on RIBs of the RIA that have been used for RI recording several times and are not expected to be used in further recording the RI about the UD. Such RIBs have similar medium characteristics to the recording medium characteristics of the UDA which changes due to the several recording operations.

As shown in FIG. 2, the optical recording apparatus comprises a pickup (PU) 110, a PU driving unit 120, a recording process unit 130, a reproducing process unit 140, an RIA analysis unit 150, a WS study area determination unit 160, a UDA condition determination unit 170, a control unit 180, and a memory 190.

The PU 110 is driven by the PU driving unit 120 to read out data from a mounted optical disk D and output electric signals corresponding to the read data to the reproducing process unit 140. The reproducing process unit 140 processes the electric signals received from the PU 110. The PU 110 also records UD signal-processed by the recording process unit 130 to the optical disk D.

The RIA analysis unit 150 analyzes the RIA based on the signals output from the reproducing process unit 140 and outputs a result of the analyzing.

The WS study area determination unit 160 determines a part of the RIA as a WS study area based on the result of analyzing the RIA by the RIA analysis unit 150.

The UDA condition determination unit 170 determines a condition of a ‘UD recording portion on the UDA’ (referred to as ‘UD recording point’) based on the result of analyzing the RIA output from the RIA analysis unit 150.

The control unit 180 controls the PU driving unit 120 such that the PU 110 performs the WS studies in a WS study area determined by the WS study area determination unit 160 or a TA and stores the WSs obtained by performing the respective WS studies to the memory 190. The controller 180 selects a proper WS of the WSs stored to the memory 190 based on a condition of the UD recording point determined by the UDA condition determination unit 170, and controls the PU driving unit 120 such that the PU 110 records the UD according to the selected WS.

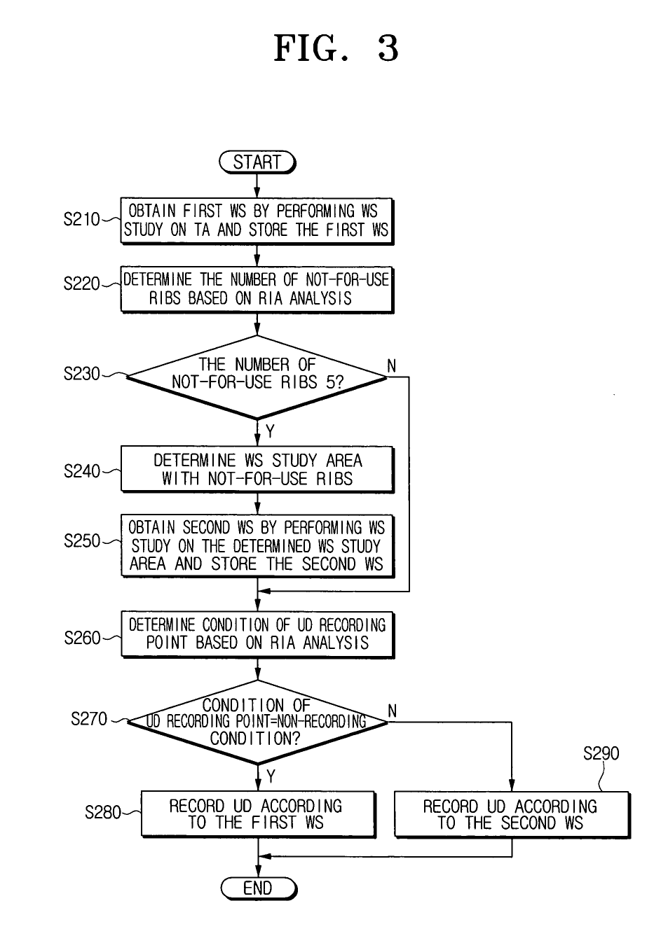

A method of optimizing a WS based on a WS study performed on an RIA according to an embodiment of the present invention will now be described with reference to FIG. 3. FIG. 3 is a flowchart illustrating a method of optimizing a WS based on a WS study performed on an RIA.

Referring to FIG. 3, a first WS is obtained and stored based on a WS study performed on a TA of the optical disk D at operation S210. More specifically, the operation S210 includes controlling the PU driving unit 120 such that the PU 110 performs a WS study on the TA of the optical disk D, and storing the first WS obtained based on the WS study to the memory 190.

The WS study area determination unit 160 determines a number of ‘not-for-use RIBs’ based on the result of analyzing the RIA at operation S220. The ‘not-for-use RIBs’ have been used several times for the RI recording and thus are not expected to be further used in recording the RI about the UD. Because the ‘not-for-use RIBs’ have been used several times for the RI recording, the recording medium characteristics of the ‘not-for-use RIBs’ become similar to the recording medium of the UDA that changes due to several recording operations.

More specifically, at operation of S220, the WS study area determination unit 160 determines the number of ‘not-for-use RIBs’ based on ‘information about the RIB performing the RI recording’ outputted as a result of analyzing the RIA by the RIA analysis unit 150. For example, if the sixth RIB performs the RI recording, the first to fifth RIBs are determined to be the ‘not-for-use RIBs’ that have been used several times for the RI recording and are not expected to be used in recording the UD anymore. Accordingly, the WS study area determination unit 160 determines that there are ‘five not-for-use RIBs’.

If the number of ‘not-for-use RIBs’ is greater than or equal to ‘5’ at operation S230, the WS study area determination unit 160 determines the ‘not-for-use RIBs’ as the WS study area at operation S240. In the above example, the first to fifth RIBs are determined as the WS study area.

The control unit 180 obtains a second WS based on a WS study performed on the WS study area determined at operation S240 and stores the second WS at operation S250. Since the operation S250 is similar to the operation S210, a detailed description of operation S250 will not be included herein.

If the number of ‘not-for-use RIBs’ is greater than or equal to 5, it turns out that a greater number of UD recording operations have been performed in the UDA. This is because the number of ‘not-for-use RIBs’ is proportional to the number of UD recording operations to the UDA. Accordingly, in the above case, the medium characteristic of the UDA is similar to those of the ‘not-for-use RIBs’ rather than the TA.

Accordingly, rather than the first WS obtained based on the WS study performed on the TA, the second WS obtained based on the WS study performed on the ‘not-for-use RIBs’ is more suitable for use in recording the UD on the UDA and thus the second WS is stored.

On the other hand, if the number of ‘not-for-use RIBs’ is less than 5 at operation S230, the operations S240 and S250 are not performed. This is because the ‘not-for-use RIBs’ under 5 are not sufficient to perform the WS study.

Also, if the number of ‘not-for-use RIBs’ is less than 5, it turns out that a small number of UD recording operations have been performed on the UDA. In this case, the medium characteristic of the UDA is more similar to the medium characteristic of the TA than to the ‘not-for-use RIBs’.

Accordingly, rather than the second WS obtained based on the WS study performed on the ‘not-for-use RIBs’, the first WS obtained based on the WS study performed on the TA is determined to be more suitable for use in recording UD to the UDA and thus the processes of obtaining and storing the second WS are omitted.

The reference value ‘5’ for the determination at operation S230 is an arbitrary value, and of course, any other reference value can be used.

The UDA condition determination unit 170 determines the condition of the UD recording point based on the result of analyzing the RIA at operation S260. More specifically, at operation S260, the UDA condition determination unit 170 determines whether the UD recording point is in a ‘non-recording condition’ or a ‘recording condition’ based on the ‘information about the number of UD recording operations on the UD recording point’ which is output as a result of RIA analysis from the RIA analysis unit 150. Herein, the ‘non-recording condition’ means that no UD has ever been recorded to the UD recording point, and the ‘recording condition’ means that at least one recording operation is performed on the UD recording point.

The reason why the condition of the UD recording point is determined at operation S260 is that the number of UD recording operations is different depending on the condition of the UD recording point. According to the number of UD recording operations, a different WS is applied to the UD recording point.

If the condition of the UD recording point is determined to be the ‘non-recording condition’ at operation S270, the controller 180 controls the UD to be recorded according to the first WS at operation 280. In this case, the medium characteristic of the UD recording point is similar to that of the TA and thus the first WS obtained based on the WS study performed on the TA is more suitable.

To be specific, at operation S280, the controller 180 selects the first WS among the WSs stored in the memory 190 and controls the PU driving unit 120 such that the UD is recorded according to the selected first WS.

If the condition of the UD recording point is determined to be the ‘recording condition’ at operation S270, the controller 180 controls the UD to be recorded according to the second WS at operation S290. In the latter case, the medium characteristic of the UD recording point is similar to those of the ‘not-for-use RIBs’ and thus the second WS obtained based on the WS study performed on the ‘not-for-use RIBs’ is more suitable. Since the operation S290 is similar to the operation S280, a detailed description of operation S290 will not be included herein.

In this embodiment, an optimal WS is selected according to whether the condition of the UD recording point is the ‘non-recording condition’ or the ‘recording condition’. However, in another embodiment, an optimal WS is selected according to whether the number of recording operations with respect to the UD recording point is greater than or less than ‘5’.

As described above, it is possible to optimize the WS by performing the WS study on the RIA that has the similar medium characteristic to that of the UDA changing due to the several recording operations. Since it is possible to obtain the optimal WS with respect to the UDA which has been used several times for UD recording and to record the UD according to the obtained optimal WS, a recording quality of the optical disk is improved. As the number of UD recording operations increases, the more effectiveness can be obtained.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of optimizing a write strategy (WS) for a rewritable optical disk, the method comprising:
determining a WS study area from a recording information area which is provided in a certain area of the rewritable optical disk and which records recording information about user data recorded to a user data area of the rewritable optical disk; and
obtaining an optimal WS by performing a WS study on the determined WS study area.

2. The method as claimed in claim 1, wherein the determining of the WS study area comprises:
determining blocks of the recording information area which are not for use in recording the recording information.

3. The method as claimed in claim 2, wherein the determining of the WS study area further comprises:
determining blocks of the recording information area that have been previously used for the recording of the recording information a predetermined number of times as the not-for-use blocks.

4. The method as claimed in claim 3, wherein the determining of the WS study area further comprises:
performing the WS study on one of the not-for-use blocks if a number of the not-for-use blocks is greater than or equal to a second predetermined number.

5. The method as claimed in claim 4, wherein the determining of the WS study area further comprises:
skipping the determining of the WS study area if the number of the not-for-use blocks is less than the second predetermined number; and
obtaining an optimal WS by performing a WS study on a test recording area of the optical disk.

6. The method as claimed in claim 5, further comprising:
determining a number of user data recording operations performed on a portion of the user data recording area;
recording the user data according to the WS obtained based on the WS study performed on the determined WS study area, if the number of the user data recording operations is greater than or equal to a third predetermined number; and
recording the user data according to the WS obtained based on the WS study performed on the test recording area, if the number of the user data recording operations is less than or equal to the third predetermined number.

7. An optical recording apparatus comprising:
a determination unit determining a WS study area from a recording information area of a rewritable optical disk, the recording information area including recording information about user data recorded to a user data area of the optical disk; and
a control unit determining an optimal WS by performing a WS study on the WS study area determined by the determination unit.

8. The optical recording apparatus as claimed in claim 7, wherein the determination unit determines the WS study area based on not-for-use blocks of the recording information area, the not-for-use blocks being not for use for recording the recording information about the user data recorded to the user data area.

9. The optical recording apparatus as claimed in claim 8, wherein the not-for-use blocks are blocks of the recording information area that have been used for the recording of the recording information a predetermined number of times.

10. The optical recording apparatus as claimed in claim 9, wherein the determination unit determines the WS study area based on the not-for-use blocks of the recording information area if a number of the not-for-use blocks is greater than or equal to a second predetermined number.

11. The optical recording apparatus as claimed in claim 10, wherein:
if the number of not-for-use blocks is less than the second predetermined number, the determination unit skips the determination of the WS study area and determines an optimal WS based on a WS study performed on a test recording area of the optical disk.

12. The optical recording apparatus as claimed in claim 11, further comprising:
a judgment unit to judge the number of user data recording operations performed on a portion of the user data recording area,
wherein:
if the number of user data recording operations is greater than or equal to a third predetermined number, the control unit controls the user data to be recorded according to the WS obtained based on the WS study performed on the WS study area determined by the determination unit, and
if the number of user data recording operations is less than the third predetermined number, the control unit controls the user data to be recorded according to the WS obtained based on the WS study performed on the test recording area.

13. A method of overwriting information on a portion of a rewritable optical disk having a user data area for recording user data and another recording area, the method comprising:
overwriting information in the portion of the user data area using a write strategy developed by a test recording in the another area, wherein:
a number of times that data has previously been recorded in the another area and a number of times that data has previously been recorded in the portion of the user data area are about equal.

14. The method of claim 13, wherein obsolete information is included in the another area prior to the test recording.

15. A method of recording user data in a rewritable optical disc having an assigned test recording area and a recording information area, the method comprising:
determining a first number of times that a portion of a user data area has been previously recorded;
recording the user data to the portion of the user data area using a write strategy developed by test recording in the assigned test area, if the first number is less than or equal to a second number;
recording the user data to the portion of the user data area using a write strategy developed by test recording in a previously recorded recording information block of the recording information area, if the first number is greater than the second number; and
if the portion of the user data area has been previously recorded more than the second number of times, selecting the recording information block in which to perform the test recording based on the recording information block having been previously recorded a third number of times at least the second number of times.

16. The method of claim 15, wherein the third number of times and the first number of times are about equal.

17. The method of claim 15, wherein the second number is at least 5.

18. The method of claim 15, wherein the third number is at least 5.
